(19) United States
(12) Patent Application Publication
(10) Pub. No.: US 2018/0310046 A1
(43) Pub. Date: Oct. 25, 2018

(54) Wearable Display Device

(71) Applicant: Matthew Cullen, La Canada, CA (US)

(72) Inventor: Matthew Cullen, La Canada, CA (US)

(21) Appl. No.: 15/961,365

(22) Filed: Apr. 24, 2018

Related U.S. Application Data
(60) Provisional application No. 62/488,994, filed on Apr. 24, 2017.

(51) Int. Cl. H04N 21/414; H04W 76/10; H04N 21/4223; H04N 21/81

(52) U.S. Cl. CPC H04N 21/41407; H04W 76/10; H04W 88/02; H04N 21/8153; H04N 21/812; H04N 21/4223

(57) ABSTRACT

A content distribution system featuring a plurality of wearable display devices. Wherein the wearable display devices may display be updated in real time via data connection with content from advertisers or other organizations.

### BACKGROUND

The present invention relates to a mobile content display system. More specifically, the present disclosure relates to a mobile content display system featuring a real-time updating wearable display.

In recent years organic user interfaces (OUI), a category of user interfaces commonly implemented on consumer devices with flexible displays have begun to be adopted by many sectors of the technology industry. These flexible displays may be created via the use of electronic paper or, more recently, the use of flexible organic light-emitting diode (OLED) displays. Not matter how the effect is achieved, computerized displays can now be bent and otherwise physically manipulated without breakage. This means such displays can be applied to substrates not typically associated with supporting a computerized display.

One notably underutilized display substrate for organic user interfaces is clothing. Presently, the integration of computerized displays and clothing is limited to basic novelties (e.g., a t-shirt that lights up) or very high-end stage productions (e.g., the helmets utilized by electronic music duo Draft Punk). There have been no major inroads made towards creating clothing which features wearable displays that can be updated in real time.

Additionally, while some garments have the ability to display computerized information, there is no current system in place which enables new content to be displayed upon a given garment to be acquired easily. Instead, the garments most people wear remain functionally similar to those from decades and even centuries past.

Still yet other issues exist with modern garments, one notable issue being their stagnant logos and branding. Most companies change their branding frequently to keep consumers interested in their products. Every time such branding changes, companies pay huge sums of money to print up new promotional materials such a t-shirts, hats, etc.

Modern technological devices including wearable display garments also lack the ability to quickly and securely sync with one another. Most Bluetooth devices use a simple 4-digit code, if any, to sync devices. This means such devices are insecure and additionally require end users who want to give authorized users access to their device more information than they may be comfortable with.

Accordingly, there is a need for a mobile content display system featuring a real-time updating wearable display.

### BRIEF SUMMARY OF THE INVENTION

To meet the needs described above and others, the present disclosure describes mobile content display systems. The systems described herein provide numerous inventive features and functions as will be described in greater detail herein.

In a first example, the systems provide a selfie detection mode in which a mobile content display system device (i.e., wearable display device) pairs with a camera device and, in response to recognition by the wearable display device that the camera is about to record a photo or video (i.e., wireless communication between the camera and the wearable display device), the wearable display device the wearable display device enters a photo/video-optimized state. This enables the wearable display device to be programmed to display a selfie-optimized image on the display when being photographed (though described as selfie-optimized, the photo/video-optimized state may be useful for selfie and non-selfie media capture). The selfie-optimized image may be a fixed reduced brightness, a static image rather than a dynamic image, etc. The selfie-optimized image may be advertising content or may be non-advertising content. The heart of this feature is the communication between the camera and the wearable display device to indicate a photo or video is to be captured and the wearable display device responding to the communication by entering the optimized state.

In a second example, a digital content packet may be downloaded to the mobile content display system device. The digital content packet includes media that can be displayed through the wearable display device. An external controller can communicate with the wearable display device to trigger the display of the media through the wearable display device. Accordingly, the display of the content may be synchronized across multiple devices to provide a coordinated response. In an example of this feature, in response to entering a geofence (or in response to proximity beacons or in response to coordinating with other location-based or proximity-based devices), the wearable display device may be presented with a user option to receive a packet of digital media content. If accepted by the user, the digital media content is then activated by an external controller, for example, in response to events occurring in the geofenced location to provide a synchronized or coordinated response through a group of wearable display devices.

In a third example, the mobile content display system device may be used as part of a live billboarding system. In such a system, users can earn money or rewards for turning their device into an advertising platform. For example, a user may use the system described in the second example above to receive digital media that is to be used an advertising context. For example, in response to a user entering a sports stadium, the wearable display device may receive advertising content for a restaurant in the stadium. The user may be compensated for his or her display of the advertising while in the stadium. The amount of money that can be earned through live billboarding may be dependent on a combination of demographics, location, and similar factors of the user and the user's planned locations.

In a fourth example, an emoji identifier can be used to identify a user or device and can further be used to pair the mobile content display system device with another device. The emoji identifier is a unique (within the system) string of emojis that functions as an identifier in the same way a login name, email address, or other identifier may otherwise be used.

Some examples of the system may include mobile content display system devices (i.e., wearable display devices) embodied in various articles of clothing (e.g., hat, t-shirt, wristband, etc.) to which a flexible video display is attached. A central processing unit within the wearable display device controls the images which are visible on the device's flexible display. An end user may select digital representations of video, animated gifs, still images, drawings, emoji, or text and store these digital representations into digital data storage media (memory) accessible to the device's processor. Input to the display can include any of the aforementioned formats as well as input from the device's integral camera(s) or any connected camera(s) accessible to the device through connection with a wireless mobile device (e.g., smartphone, tablet, etc.).

An end user may select the order and duration of the images to be shown on the flexible display in a sort of playlist; the display sequence being executed by the central processing unit. Electrical energy for the device is supplied by an electrical power source (e.g., battery). Additional power can be provided by plugging in an external supplemental battery pack or attaching it to an end user's wireless mobile device to draw power from the connected device. Wireless power may be delivered to the device when the wearable device is placed on a charging station and the power charging receptacle is in range of the wireless power transfer point.

In one preferred embodiment, the wireless flexible display device may take the form of a baseball cap which is capable of displaying electronic images (both static and moving) on a flexible display, integrated into the body of the baseball cap to provide a comfortable, wearable form factor. The images may be displayed in the location a team's logo is typically displayed upon a traditional baseball hat or cap (called a crown). The images are delivered to the flexible display from the central processing unit which controls the visible images on the flexible display, a data storage medium, and an electronic power source providing power to the CPU. The data storage medium may be removable (SD, MicroSD, or another removable storage medium) or permanent in nature depending on the needs of a given instance of the system.

The images, video, etc. displayed upon the wireless flexible display device may be transmitted to the wearable display device via any number of wireless communications mediums. Such mediums may include Bluetooth, ZigBee, Near Field Communication (NFC), RF, Wi-Fi, and/or wireless telecommunications (3G, 4G LTE, 5G, etc.) that enable the device to send and receive data from external devices, servers, databases, etc. The wearable display device may also be controlled by a wireless input device or devices. In such an embodiment, a wirelessly connected input device controls the central processing unit, in turn controlling what electronic images were displayed on the flexible display. In essence this would turn the hat, shirt, etc. into a mobile display allowing various input devices (e.g., a smart phone, tablet, game console, etc.) to utilizes the wearable display like a traditional computer monitor.

Some embodiments of the present invention may feature a device which includes a camera (or cameras) that is capable of recording electronic still images, electronic moving images, and/or electronic moving images in 360 degrees. The camera is capable of recording data upon the device's internal storage, removable storage, and/or transmitting the images, data, etc. from the camera to a paired wireless mobile device, server, etc. The camera(s) have the capability to capture, record, and/or transmit standard definition images and video, HD, and/or 4K. Capture and recording of the camera streams can happen simultaneously for all connected cameras. In addition to one or more built-in cameras, the device may also feature a microphone or microphones capable of detecting sounds in frequencies that are audible to the human ear and those beyond the capabilities of the human ear. Certain frequencies, audible or inaudible, can trigger commands or coded events on the electronic central processing unit, or the connected wireless mobile device.

Other embodiments of the present invention may feature a device with tactile contact sensors upon the outwardly visible surface of said electronic screen display (e.g., a touchscreen), and the previously described flexible electronic screen display is able to communicate the location, and pressure of said tactile contact to said central processing unit. Such a device may also feature a capacitive touch sensor that is connected to various input points on the wearable device using conductive thread, buttons, conductive ink, or other touch sensitive input areas. This will allow for various embroidery, logos, etc. to act as active touch input areas.

Still yet other embodiments of the present invention may feature a device with an ambient light sensor capable of detecting the amount of ambient light present and communicating that information back to the electronic central processing unit. The lights can be programmed and modified to dim, change color, and/or sync with music or ambient noise as well as be manually controlled by a smartphone application. The lights may also be adjusted based off the brightness of the display automatically to optimize the display's power consumption and visibility. In addition, features tied to ambient light levels when paired with location data and geofence data can trigger specific features of the device. (e.g., if the device enters the geofence of a theater, it will disable the device's lights).

Geofence data may be detected by the various wireless antennas contained within the wearable device or its linked mobile computing device. This data may be bolstered and/or supplied by GPS data, obtained via a GPS chip within the device. The GPS chip may enable the device to provide location data and allow for specific features, events and triggers to be tied to the location of the device as mentioned above.

Another embodiment of the present invention may feature a central processing unit capable of processing multiple layers of video or multiple videos in a matrix on the display and displaying upon the connected flexible display(s) multiple video assets simultaneously, or a combination of static, moving, and/or text/animated text layered over moving or static images. Additionally, text input on a connected wireless mobile device may be able to send text that will be processed into animated text to be layered and displayed on the flexible display in near real-time over video assets, or user selected static or animated backgrounds.

Still yet other embodiments of the present invention may feature a device that has a small motor that produces a vibration that gives haptic feedback. Several small motors can be connected to the central processing unit in various locations on the wearable device to provide haptic feedback to the user to provide prompts to look or move a certain direction, or for gameplay feedback, or to add an additional sensory component to various media.

In addition to the wearable display device described above, the present invention may also include the accompanying systems and methods which enable the wearable display device to function. For instance, the content displayed by the wearable device may be dynamic in nature, with new content being displayed depending on where the user is located. Such dynamic changes to what is displayed by the wearable device may be provided by content packet downloads.

Each content packet may be provided by a kiosk or other form of communication node which enables end users to download a content packet when physically near. For example, if a user attends a music festival, there may be a kiosk set up which enables device wearers to approach it and download via Bluetooth, NFC, Wi-Fi, etc. a content packet which contains a set of images, logos, or multimedia display(s) which can then be displayed upon the wearable device. Although described as a kiosk, it is contemplated that the content packet may be pushed to the wearable device without the user directly interacting with a kiosk or other similar device, for example, the content packet may be downloaded through a mobile application running on an associated mobile device. The content packet may be coded, or password protected in a manner which prevents it from being shared with others and only obtained from a given kiosk, within a certain geofenced location, or similarly location controlled. In this way, the content packet from a given music festival or other location-based event can only be collected by users attending the event. As a consequence, attendance at an event may be more attractive as a user needs to be in physical attendance to obtain the content packet.

The manner in which a content packet is downloaded, and other communication is carried out by the presently described systems can be done based off traditional passcodes or via unique strings of emojis. For example, if the kiosk described above may display a string for four emojis as a code which enables the download of the content packet from the kiosk.

The content packets which are downloaded also have the potential to be monetized via the present invention's live billboarding features. In modern society, many small jobs are being crowd sourced. This aspect of the present invention enables user's wearable devices to act as advertisement platforms for a given brand to earn money or other types of valuable consideration from a company in exchange for the advertisements. For example, if a restaurant wants to advertise at the music festival mentioned above, the restaurant can offer to compensate users in exchange for displaying the restaurant's logo on the user's wearable device while attending the music festival (i.e., within a geofence circumscribing the location of the music festival). This enables targeted marketing to be taken a previously unobtainable level, with peers of a target audience becoming a live billboard for a product.

Yet another functionality enabled by the present invention is the ability to optimize the wearable device's display for photography or other media capture (e.g., being the subject of a video recording). Given the wearable device's various sensors and communication antennas, the wearable device and can detect or be informed when a photograph is going to be taken of the wearable device and, in response, display an image optimized for photographic capture. For instance, if a user is live billboarding at the music festival and goes to take a selfie with a friend, the wearable device (which is in communication with the live billboarding user's mobile device) will switch from displaying an animated advertisement to a still image. This still image may be the advertiser's logo, etc. which will show up clearly in a selfie, while the animated advertisement's content may not. Once the selfie is taken and the mobile device's camera is deactivated, the mobile device may then again communicate with the wearable device to resume playing the animated advertisement.

This aspect of the present invention may be described as a media capture display optimization system comprising a wearable display device displaying dynamic media on a display, the wearable display device further including a first controller controlling the display, a memory storing the dynamic media and a static image, and a first wireless communication module; a camera device including a second controller controlling a media capture module and a second wireless communication module; wherein, in response to the second controller placing the media capture module in a media capture mode, the second wireless communication module communicates to the first wireless communication module; and in response to the communication from the second wireless communication module, the first controller causes the display to display the static image.

The wearable display device mentioned above may be a hat, shirt, etc. and utilize a flexible display. The display may exhibit dynamic media which includes video and/or dynamic display settings. The camera device mentioned above may be a smartphone and the media capture mode may include activation of a front facing or any other camera of the smartphone. The media capture mode mentioned above may capture video or still images.

This aspect of the invention may also be described as a method, comprising a wearable display device communicatively paired to a mobile computing device featuring a front facing camera, wherein, the wearable display device displays at regular intervals a series of digital content including at least one still image and one video, wherein, in response to the mobile computing device's front facing camera being activated, displaying a still image while the front facing camera of the mobile computing device is active, and resuming, at regular intervals, the display of a series of digital content including at least one still image and one video upon deactivation of the mobile computing device's featuring a front facing camera.

Another aspect of the present invention may be described as a media content control system comprising a plurality of wearable display devices, each wearable display device including a controller controlling a display; a memory; and a wireless communication module; a location-based content distribution and control system including a content packet server hosting at least one media content packet; and a content activation controller; wherein, in response to one of the plurality of wearable display devices entering a prescribed location, the content packet server presents an option to download the at least one media content packet; in response to receiving the option to download the at least one media content packet, at least one of the plurality of wearable display devices downloading the at least one media content packet; in response to a control signal presented by the content activation controller, each of the plurality of wearable display devices that downloaded the at least one media content packet display media content from the media content packet on the display.

The wearable display device mentioned above may be a hat, shirt, etc. The prescribed location may be a geofence or a distance from a proximity-based device. The proximity-based device is a proximity beacon. The content activation controller may communicate with the wireless communication module of the wearable display devices. The content activation controller may communicate with the wireless communication module of the wearable display devices via ultrasonic communication, the Internet, etc.

In response to one of the plurality of wearable display devices entering a prescribed location as described above, the content packet server may present an option to download the at least one of at least two media content packets. The control signal presented by the content activation controller may cause each of the plurality of wearable display devices that downloaded a first media content packet to display first media content and each of the plurality of wearable display devices that downloaded a second media content packet to display second media content different from the first media content. The displayed media content from the media content packet may vary depending of a location of the wearable display device. The displayed media content from the media content packet may also vary depending on a location of the wearable display device such that a dynamic media presentation is displayed across a plurality of wearable display devices in adjacent locations.

This aspect of the system may also be described as a method, comprising a wearable display device, kiosk, and centralized server, wherein, the kiosk detects the wearable display device via wireless communication signal; upon detection, the kiosk establishes communication with the wearable display device; transfers via the established means of communication one or more content packets featuring at least one digital image or video to the wearable display device from the centralized server; and displaying the at least one digital image or video from the content packet which was transferred to the wearable display device upon the wearable display device.

Yet another aspect of the present invention may be described as a digital advertising system comprising a wearable display device including a wearable display device controller controlling a display; a memory; and a wireless communication module; and a content distribution and control system including a content packet server hosting at least one media content packet including advertising content; and a content tracking controller; wherein, in response to downloading the media content packet including advertising content onto the memory, the wearable display device displays the advertising content on the display; further wherein, the content tracking controller communicates with the wearable display device controller to track when the advertising content is on the display. The wearable display device may further include a location module through which the wireless communication module can communicate the location of the wearable display device to the content tracking controller.

The mobile computing device mentioned above may be in communication with the wireless communication module, the mobile computing device communicating the location of the wearable display device to the content tracking controller. The wearable display device mentioned above may be a hat, shirt, etc. Compensation for the display of the advertising content may be based on at least a time and a location of the display of the advertising content. Compensation for the display of the advertising content may also be based on at least a user profile associated with the wearable display device or based on at least a user profile associated with the wearable display device.

A method, comprising downloading of a content packet created by an advertiser to a wearable display device, wherein the content packet features at least one piece of advertiser content; displaying the at least one piece of advertiser content upon the wearable display device; recording the duration the at least one piece of advertiser content is displayed upon the wearable display device; communicating the duration the at least one piece of advertiser content is displayed upon the wearable display device to the advertiser that created the content; and transferring monetary value to an account associated with the wearable display device that displayed the at least one piece of advertiser content.

Another aspect of the present invention is a system for enabling communication between two devices comprising a first device including a first contact identifier and an associated emoji code, wherein the emoji code is a unique set of one or more emojis in an ordered combination; an emoji authentication server storing the association between the first contact identifier and the emoji code; a second device that communicatively connects to the first device by providing the emoji code to the authentication server and, in response to the authentication server receiving the emoji code, the authentication server negotiates a communication connection between the first device and the second device. The first contact identifier is a phone number, an email address, etc. The communication connection negotiated may be a Bluetooth pairing, a phone call, an SMS communication, or an email. The communication connection negotiated may enable the communication of a data file between the first device and the second device.

This aspect of the invention may also be described as a method of authentication, comprising a database storing a number of records with fields including an authorization field and field corresponding to an authorization code in the form of emojis, wherein, in response to a user input of an emoji code, the record which corresponds to this emoji code updates the authorization field, providing access to computerized content for the user who input the emoji code.

A goal of the present system is to disrupt a stagnant intersection of fashion, technology, and marketing. Baseball caps and other articles of clothing have been widely left behind by the technological revolution. Given recent innovations in flexible computerized displays, etc. the clothing human's wear is rife for technological integration. However, almost every article of clothing featuring a computerized display has been a novelty up to this point, with no real notable changes to the fashion/technology overlap; nor have these attempts been particularly appealing to consumers. Additionally, no attempts have been made to crowd source location-dependent advertising upon clothing integrated with technology. The present invention represents a paradigm shift in the world of fashion, technology, and marketing.

An advantage of the present system is that is creates a new form advertising as well as a new potential revenue source. Ride sharing and food delivery are two examples of industries which have been created or revolutionized by technological platforms. Such innovations have enabled these tasks to be carried out by large groups of people instead of a few companies. The present invention enables the same approach, with the potential for the crowd at a concert or sporting event to take the place of a paid ad on the stadium's jumbotron or a physical billboard outside the event. Each end user who dons a mobile display device such as a hat or t-shirt can instantly become a walking ad for a product and just as quickly stop. This will enable end users to gain additional income or other benefits while also providing advertisers an alternative to static advertisements.

Another advantage of the present system is that it enables an end user to acquire the most up to date advertisements or branding via packet content downloads. Many sports teams and companies change their logo each year; the present invention can account for these updates meaning if someone wants a baseball cap with their team's newest logo, they need to simply purchase or otherwise acquire the content pack featuring this logo rather than pay for a brand-new hat each season. Additionally, for advertisers and companies who want to keep their branding consistent, the present invention enables them to update all of their employee's uniform logos, advertisements, etc. instantaneously.

Yet another advantage of the present system is its ease of use and automated features which enable ends users to automatically present branding and advertisements in the best manner possible. The present system can utilize various cameras and sensors to detect when the wearable display device is being photographed to display an image optimized for the best picture (and marketing opportunity) possible. Additionally, through the use of emoji pairing, devices can be pair quickly using familiar inputs for today's younger generations and prevents the need for convoluted authentication.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a schematic diagram of a mobile content display system.

FIG. 2A is a schematic diagram of a content packet download system.

FIG. 2B is a flowchart demonstrating a method of downloading a content packet.

FIG. 2C is a flowchart demonstrating a method of generating revenue via live billboarding.

FIG. 3 is a schematic diagram of a system in which a wearable display device obtains content.

FIG. 4 is a schematic diagram of a wearable display device.

FIG. 5 is a side view of a wearable display device.

FIG. 6 is a front view of a wearable display device.

FIG. 7 is a bottom view of a wearable display device.

FIG. 8A illustrates a mobile content display system detecting a selfie.

FIG. 8B is a flowchart demonstrating a method of a mobile content display system detecting a selfie.

### DETAILED DESCRIPTION OF THE INVENTION

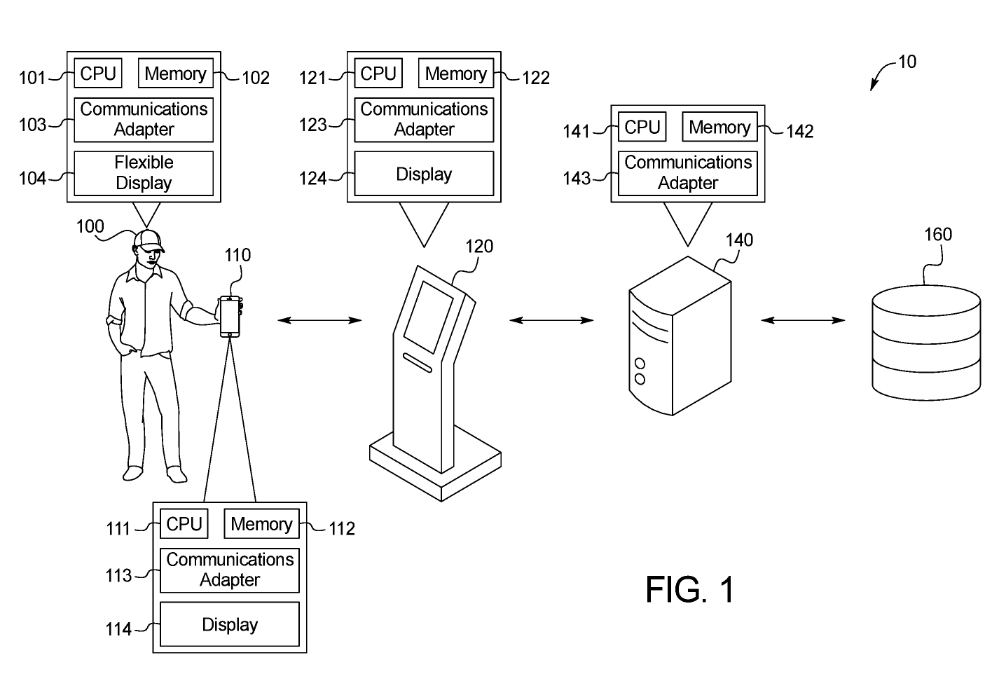

FIG. 1 is a schematic diagram of one example of a mobile content display system 10. As shown in the example provided in FIG. 1, the mobile content display system 10 features a wearable display device 100, a mobile computing device 110, a content download kiosk 120, a centralized server 140, and one or more external data sources 160. The wearable display device 100 may feature at least a central processor, or controller, (CPU) 101, removable or persistent memory 102, at least one communications controller/adapter 103, and at least one flexible computerized display 104. The CPU 101 may send and receive information from one or more external sources and, in this example, communicates with an end user's mobile computing device 110. The mobile computing device 110 may be a smart phone, tablet, laptop, etc. which is configured to communicate with the wearable display device 100. Communication may be carried out by Wi-Fi, ZigBee, Bluetooth, Near Field Communication (NFC), RF, telecommunications, or any other means of communicating computerized data.

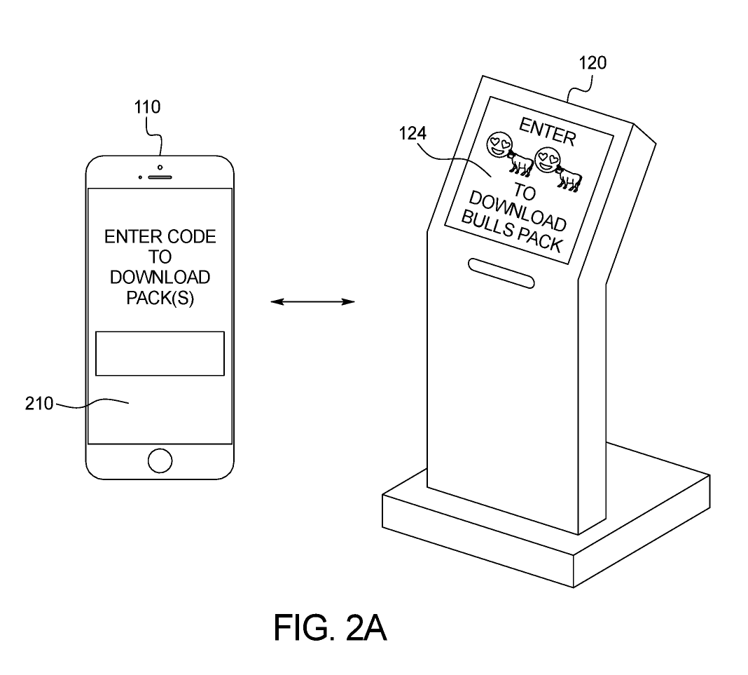

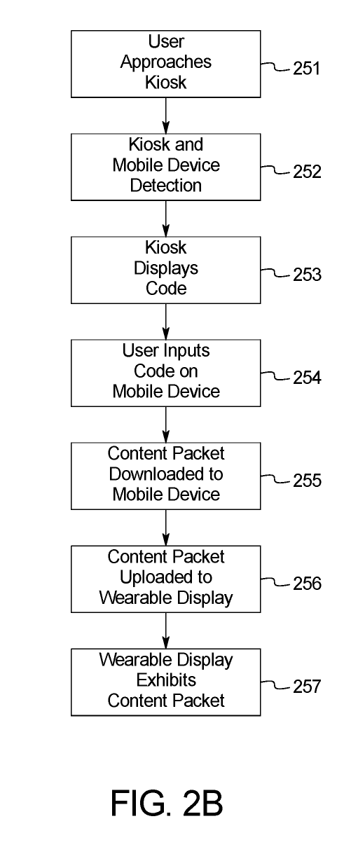

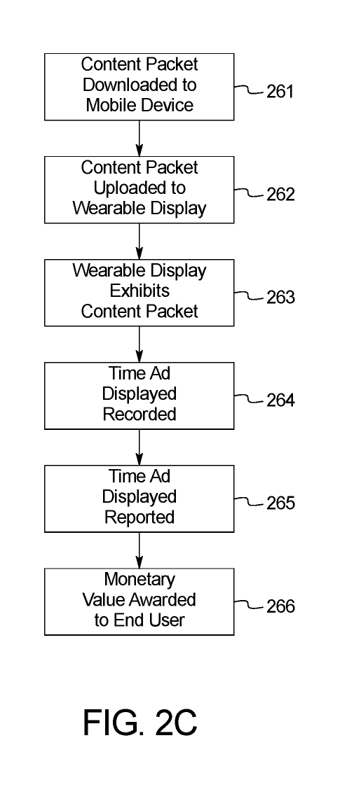

The mobile computing device 110, in this example, also includes a central processor, or controller, (CPU) 111, a removable or persistent memory 112, and at least one communications controller 113. The mobile computing device 110 also includes a display 114 that enables the end user to control the mobile computing device 110 and also control the wearable display device 100. Control of the wearable display device 100 may be done via a graphical user interface (GUI) of a stand-alone application 210 (see FIG. 2A) running upon the mobile computing device 110 that enables the end user to control what is displayed upon the one or more flexible computerized display(s) 104 of the wearable display device 100.

New content to be displayed upon the wearable display device 100 may be obtained from the internet or, in this example, via a physical kiosk 120. The content download kiosk 120 in this example may be stationed at events or notable locations (e.g., the Smithsonian) and set up to enable end users within a certain proximity to download content from the kiosk 120. These end users may pay to obtain the content packet from a concert or sports team and alternatively may be paid to display an advertiser's logo, etc. (see FIG. 2C). To enable the download of these content packets, the kiosk 120 may also include a central processor, or controller, (CPU) 121, removable or persistent memory 122, at least one communications controller 123, and a display 124.

The kiosk 120, in this example, communicates with the mobile computing device 110 via Bluetooth or another form of short range data communication. This ensures only those who are physically close to the kiosk can download the available content packet(s). This can be used to provide a form of scarcity to certain content packets (e.g., an end user must attend Coachella 2018 to obtain the Coachella 2018 content packet) and also provides advertisers with tight control of where their product is being advertised (see FIG. 2C).

It should be noted that the physical kiosk 120 is not required, and hidden Bluetooth or other communication nodes may be utilized by certain embodiments of the presently disclosed system 10. For example, the Smithsonian may set up a geofence using GPS and/or Bluetooth transmitters which enable an end user to download a Smithsonian themed content packet when they are within the museum grounds.

In addition to being location-dependent for purposes of receiving the content, the content may be removed from the wearable device (or inactivated in the wearable device) upon exiting the location. This feature can be used to ensure certain content is only usable within a prescribed location. For example, the wearable display device 100 may periodically poll its location to confirm the wearable display device 100 is within a prescribed location with respect to given content. If so, the content remains accessible. If not, the content is removed from the memory 102 of the wearable display device 100.

In addition to being location-based, content packets may be time dependent. As such, the content may only be acquired at a given time or within a given window of time, may only be active for a given duration or within a given window of time, or may be removed or inactivated at a given time.

No matter what is utilized to transmit information to end user's mobile computing devices 110, the content packets and other information for transmission to end users can be stored and managed in at least one centralized server 140. The centralized sever 140 in this example is a physical, stand-alone server but may also be a distributed server solution, cloud server, etc. The centralized server 140 features a central processor, or controller, (CPU) 141, memory 142, and at least one communications controller 143. The memory 142 of the centralized server 140 stores content packet data as well as metadata related to storage and management of the content packets.

In some embodiments, the end user's mobile computing device(s) 110 may also, or alternatively, communicate directly with the centralized server 140 via the internet, with the server 140 storing end user's profiles and other information (e.g., what content packets each has acquired). The interaction between the mobile computing device(s) 110 and the server 140 may be managed via a graphical user interface of a stand-alone application 210 (see FIG. 2) running on the mobile computing device(s) 110. Similarly, in some embodiments, the wearable display device 100 may communicate directly with the centralized server 140, bypassing a need for the mobile computing device 110 and the kiosk 120.

In some embodiments, the content to be displayed upon a wearable display device 100 may be provided by at least one external data source 160. The external data source 160 may be an advertiser's database, ad network, sports league database, multimedia database, or any other external source of computerized data which can provide content that can be displayed upon a wearable display device 100. The information provided by the external data source(s) 160 in this example is uploaded, via the internet, to the centralized server 140 which processes and collates the data, so as to be optimized for upload to a wearable display device 100.

FIG. 2A is a schematic diagram of a content packet download system including a mobile computing device 110 and a kiosk 120. As shown in FIG. 2A, when an end user is in range of a content download kiosk 120, the mobile computing device 110 may detect the kiosk 120 and display upon a graphical user interface of a stand-alone application 210 a prompt to enter an emoji code to download a given content packet. The emoji code, in this example, may be displayed upon the kiosk's 120 display 124. Once the end user enters the emoji code, the system 10 authenticates the end user's device and starts the download of the content packet. The download and communication may occur by any functionally relevant means, but in this example is carried out by Bluetooth. Once downloaded to the mobile computing device 110, the content packet may then be uploaded to the wearable display device 100. It should be noted that in some embodiments of the present system 10, the wearable display device 100 may communicate directly with the kiosk 120, etc. without the need for a mobile computing device 110 to be present. Additionally, it is fully imagined that some or all of the physically separate components of the disclosed system may be integrated into one another as technology advances.

In the FIG. 2A example, an end user is attending a Chicago Bulls game on St. Patrick's Day. At the United Center, where the Bulls play, there may be one of more kiosks 120 set up that can detect and interact with end user mobile computing devices 110. The end users may approach one of the kiosks 120 and, when the user is within range of a Bluetooth connection (e.g., 100 meters or less) the application 210 on the smart phone (mobile computing device 110) may prompt the user to enter the four-character emoji code—alternating “love” and “bull” emojis—which enables the mobile computing device 100 to download an exclusive green Chicago Bulls St. Patrick's Day logo as part of a content packet. The end user may be charged for the download or allowed to download it for free depending on how the content provider wishes to monetize their content.

The emoji code mentioned above may also act as an emoji identifier. Emoji identifiers may function similarly to an email or phone number, with one or more servers acting to authenticate and resolve what emoji identifier belongs to which end user, hardware device, or other entity. The emoji identifier may in actuality be any string of Unicode characters including alphanumeric numbers, symbols, emojis, etc. Each unique string selected by an end user as one of their emoji identifiers may be stored in one or more server databases which enable these servers to authenticate text messages, phone calls, emails, etc. directed towards a given emoji identifier.

For example, the Bulls emoji code in this example could also be the universal Bulls emoji identifier. This identifier may enable an end user to submit an inquiry in text message form for the Chicago Bulls Organization without requiring the Bulls to provide an actual phone number or email address. If an end user was to send an email to the emoji identifier of the four-character emoji Bulls identifier (alternating “love” and “bull” emojis) a centralized server would receive this email similar to a traditional email server with the additional step of identifying that the four-character emoji identifier corresponds to the Chicago Bulls organization, then delivering the message to the Bulls via their preferred method (e.g., a messaging bus, enterprise server, etc.).

The use of emoji identifiers can also be valuable in scenarios when anonymity is preferred. For instance, giving out one's phone number or email at a bar can be unsettling to some, so it may be preferred by many to provide their emoji identifier which is essentially anonymous so long as the authentication server's records are kept secret. In the example above, if a young man and woman meet at a Bulls game, they can simply exchange emoji identifiers without the need to reveal any other information about themselves. After this, they can text message one another, etc. and if one of them becomes uncomfortable, they can block the other user's emoji code from contacting them (recorded in the server(s)) and also change their emoji code or adopt a new one instantly to avoid harassment, stalking, etc.

Additionally, a given end user may utilize multiple emoji codes during different facets of their lives to keep work and personal life separate. For instance, if a celebrity wants to interact with fans, they may provide one emoji identifier which sends messages to a designated fan correspondence email account while also maintaining a personal emoji identifier for their close friends.

Finally, emoji identifiers or codes can also act as links to content. For example, the Bulls code discussed above can act to enable an end user to connect to a kiosk 120 and download content and also act as a sort of messaging address when someone sends an SMS message to the four-character emoji Bulls identifier. The use of this four-character emoji Bulls identifier may also act to trigger a Bulls advertisement or display a multimedia rich image within an email or text message. Again, in this situation the servers which host the emoji code/identifier system would detect the use of the assigned emoji string and then display the Bulls logo in place of the emoji string in an email, for example.

FIG. 2B is a flowchart demonstrating how a content packet is downloaded. As shown in FIG. 2B, in some embodiments, at a first step 251 an end user approaches a kiosk 120. As the end user approaches the kiosk 120, the mobile computing device 110 (e.g., smartphone) detects the kiosk 120 and/or vice versa (step 252). The detection may be carried out via wireless signal, notably in this example, Bluetooth is utilized for the detection. Once at least one mobile computing device 110 is detected, the kiosk 120 will display a code (step 253). The code displayed may be a traditional alphanumeric passcode or an emoji ID, depending on the manner in which the system 10 is set up. Once the end user enters this code into the mobile computing device 110 (step 254), a wireless connection between the mobile computing device 110 and kiosk 120 is made through which at least one content packet is communicated (step 255). Once the content packet(s) are downloaded to an end user's smartphone or tablet (mobile computing device 110) the content packet(s) may be uploaded to one or more wearable display device(s) 100 (step 256). This upload may again be done by any wireless (or wired) means of transmitting data between the mobile computing device 110 and wearable device 100. Once the content packets are uploaded to the wearable device 100 (e.g., a baseball hat) the wearable device can display the contents of the content packet including logos, images, multimedia files, etc. (step 257).

FIG. 2C is a flowchart demonstrating a method of generating revenue via live billboarding. Live billboarding is used to describe a system in which calls for an end user to display upon their wearable device 100 one or more advertisements a company wishes to display to potential consumers. In return for displaying such advertisements, the end user may be rewarded with monetary value, free products or services, or other valuable consideration. As shown in FIG. 2C, to begin live billboarding, an end user may, at a first step download an advertiser's content packet to the mobile computing device 110 (step 261). The download may be from a kiosk 120 (as shown in FIG. 2A), the internet, an email, file share, etc. Once downloaded to a mobile computing device 110, the content packet may then be uploaded to one or more wearable display devices 100 (step 262). The upload may be carried out by Bluetooth, Wi-Fi, etc. Alternatively, the content packet may be uploaded directly to the wearable display device 100 from the origin.

Once the upload is complete, the end user can opt to display the advertiser's content packet (step 263). This content packet can be still images, video, etc. which will be displayed upon the wearable display device(s) 100 and optimized for display on each type of wearable device 100 (e.g., a hat, visor, head band, t-shirt, etc.). When an end user begins displaying the ad content upon the wearable device 100, the system 10 tracks how long the advertiser's content is displayed by the end user (step 264). In some embodiments, there may be a pre-agreed upon pay schedule which determines the pay-per-minute an advertisement is displayed or a set amount of time for display which must be met to obtain a certain payout.

After the end user stops displaying an advertiser's content, the amount of display time recorded is then reported by the system 10 to the corresponding advertiser (step 265). Such reporting may be handled by the centralized system server(s) 140 which may enable advertisers to log in via a web portal and review the amount of time their advertisements have been displayed by various end users. Such information concerning display time may be transferred to one or more external data sources 160 automatically by the system 10. No matter how the information is reported, the advertisers can then use this information to award monetary or other value to the end user who has acted as a live billboard (step 266). In some embodiments, the payout may be automated and tied to online payment services such as PayPal and, at predetermined intervals, pay the end users for their service.

It should be noted that the present system 10 may enable a listing website or database to be created through which advertisers can identify end users who would be ideal candidates for live billboarding. When creating an account with the present system 10, end users who own one or more wearable display devices 100 can enter various demographic data about themselves such as age, gender, ethnicity, and also lifestyle information. Such lifestyle information could include information about if a user frequents bars, concerts, gyms, museums, etc. This lifestyle information can be corroborated by the system's ability to track 10 GPS data as well as end users giving the system 10 access to their social media accounts. From this data, the system 10 may automatically rank and assign live billboard targets for advertisers based off their own specified target audience.

For example, if a beverage company was seeking to market a new line of hang over recovery drinks, their target audience would likely be younger adults who party late into the night at bars, clubs, and concerts. Knowing this, the present system 10 can be set up to find profiles of end users who are a certain age (e.g., 21-35) and frequent bars, clubs, etc. End users who are actually physically at a bar or club will be given additional weight in the rankings generated by the system, with even more additional weight to those tweeting or otherwise posting something online about partying.

From these automated rankings, the system 10 can, in real time, assign an end user a real billboarding assignment which the end user can then accept or decline. The system can then track the assigned end user(s) location, social media posts, etc. so if they leave the bar or club, the live billboarding assignment will end. The system 10 can also use image recognition or other means to determine if the end user has posted photographs or video featuring the advertisers content displayed upon their wearable device 100 to social media for additional monetary reward. If an end user leaves a targeted bar, concert, etc. the system 10 can then attempt to find another suitable end user for live billboarding. In this way, the advertisers will be able to pay for very specific and targeted advertisements.

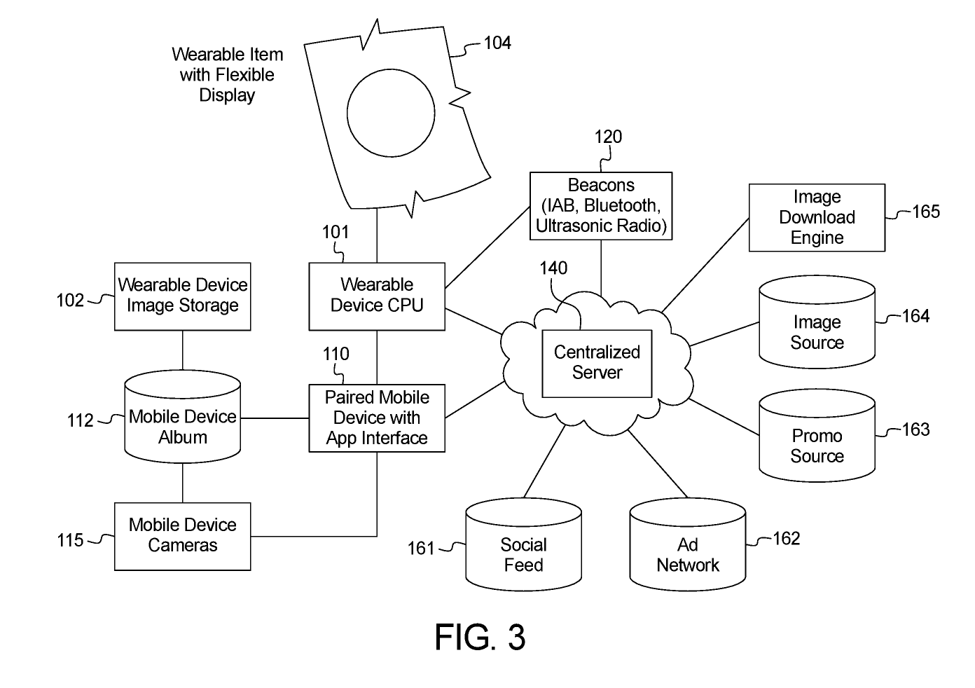

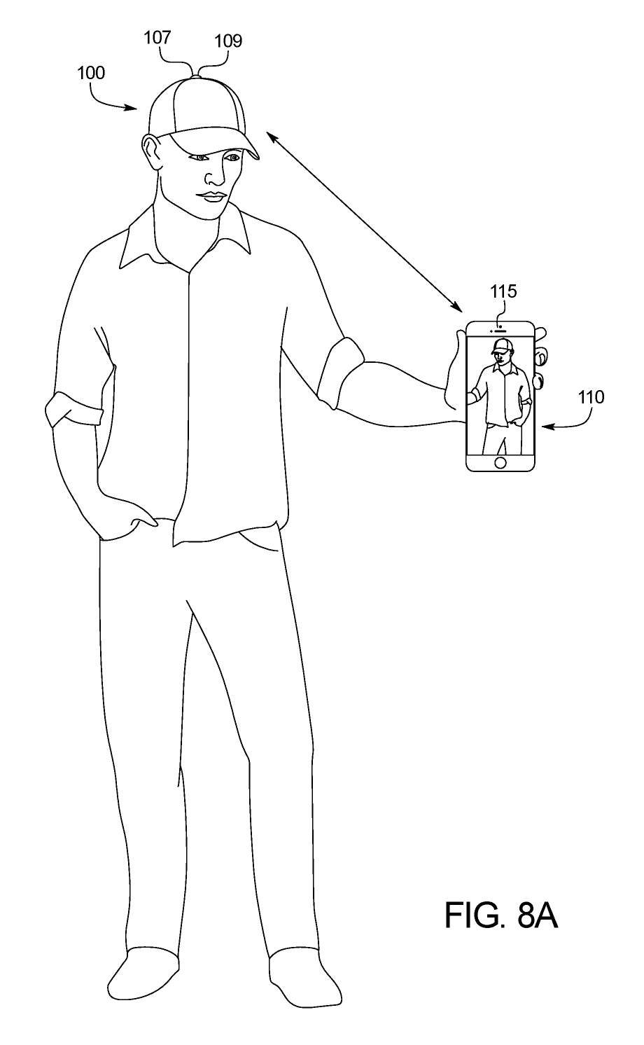

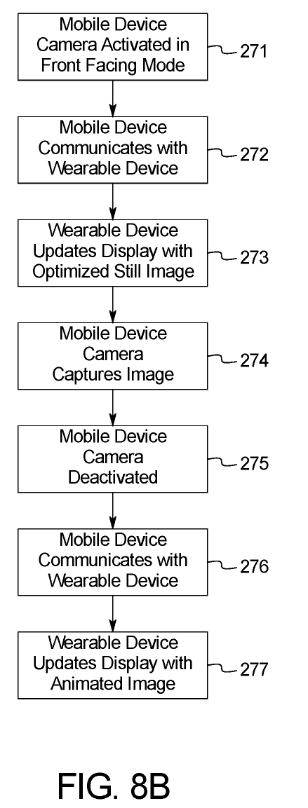

FIG. 3 is a schematic diagram of a system in which a wearable display device 100 obtains content. As shown in FIG. 3, the wearable display device 100 may feature at least a central processor or controller (CPU) 101, removable or persistent memory storage 102, a communications adapter 103, and at least one flexible computerized display 104. The wearable display device 100 is paired via the communications adapter 103 (in this example via a Bluetooth communications module) with a mobile computing device 110. The mobile computing device 110 features a control application 210 (see FIG. 2A), memory 112, and in this embodiment one or more cameras 115 which may capture images that can be displayed upon the wearable device 100 and also utilized by the system 10 to optimize display of content upon the wearable device 100 (see FIG. 8A). In this example, the centralized server 140 communicates with both the wearable device 100 and mobile computing device 110 via at least one electronic communications network (e.g., the internet). The wearable device 100 and centralized server 140 also communicate with one or more beacons and/or kiosks 120 (see FIG. 1) in this example. The centralized server 140 acts to coordinate, format, and/or collate data from many different external data sources 160, in this example the data sources include social network data feeds 161, advertisement networks 162, promotional data sources 163, image data sources 164, and/or image download engines 165.

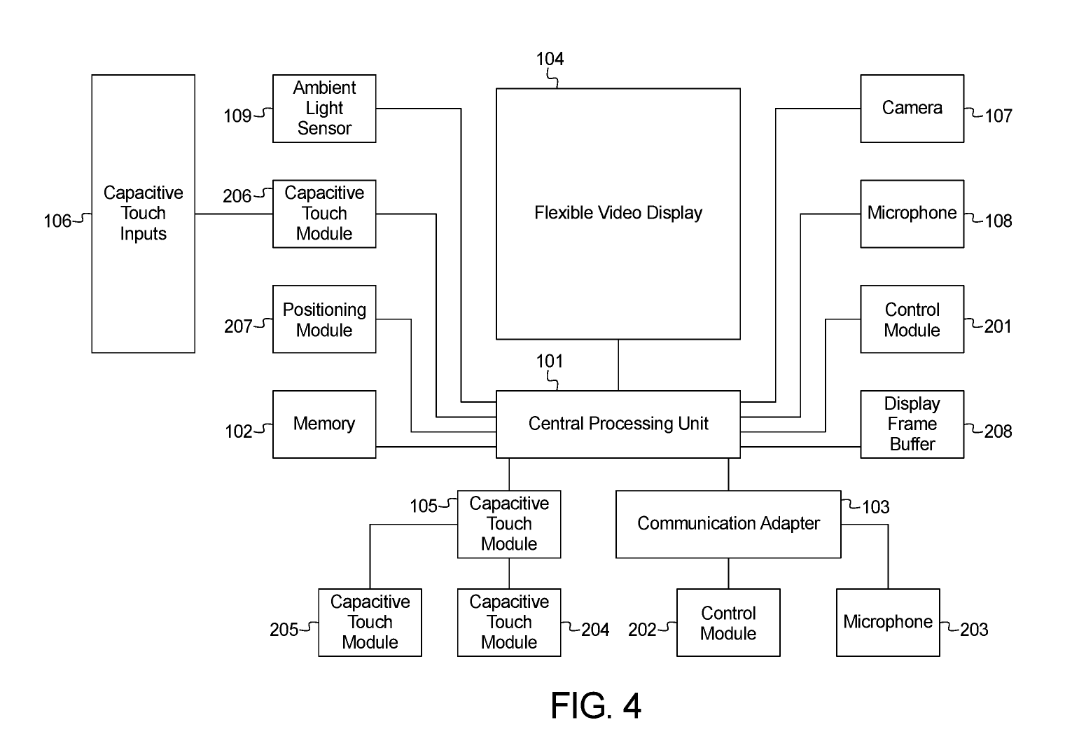

FIG. 4 is a schematic diagram of a wearable display device 100 and its components. As shown in FIG. 4, the wearable display device 100 may feature at least a central processor or controller (CPU) 101, memory storage 102, at least one communications controller/adapter 103, and at least one flexible computerized display 104. The device may also feature a power supply 105, capacitive touch inputs 106, integrated camera 107, microphone 108, and light sensor(s) 109. The CPU 101 may itself feature various modules, buffers, and controllers which enable the CPU 101 to accept input and control output of digital information. For example, the capacitive touch inputs 106 communicate with a capacitive touch module 206 which interprets these inputs and enables them to control the device 100. The content displayed upon the flexible video display(s) 104 is controlled by the CPU 101 (including a control module 201) which features a positioning module 207 and display frame buffer 208. All of these modules and controllers act to format and optimize content for display upon a given wearable device 100. The power supply 105 may feature both wired 204 and wireless 205 charging ports to enable the recharge of the device's 100 internal batteries. The communications adapter 103 may feature wireless antennas 203 (e.g., Bluetooth, Wi-Fi, etc.) as well as wired communication port(s) 202 (e.g., USB, Lighting Connector, SD Card, etc.).

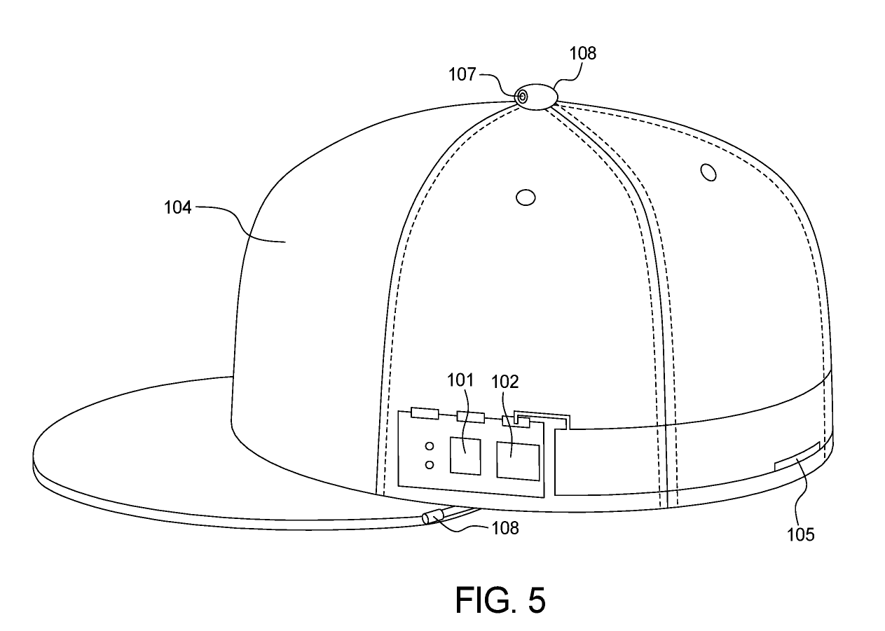

FIG. 5 is a side view of a wearable display device 100. As shown in FIG. 5, the wearable device 100 may have its various components (discussed in FIG. 4) laid out in a manner that is both comfortable for end users and also maximizes functionality. In this example, the wearable display device 100 is a baseball cap including a crown that features a flexible display device 104. The top button of the cap doubles as a location for a built-in camera 107 and ambient light sensor 109. Upon the inner band of the cap, the computerized components that control and power the device (e.g., CPU 101, memory 102, power supply 105, etc.) are positioned in an ergonomic manner. The microphone 108 is positioned around the transition point between the brim of the cap and main body.

It should be noted that the positioning of the camera 107, light sensor 109, and microphone 108 are done to maintain the overall look of a traditional baseball cap while also maximizing functionality. For example, the camera 107 in this example is positioned facing the front of the cap meaning whatever the end user sees, the camera 107 sees. This can be important for many functions, one of them being detection of selfies and optimizing the content displayed by the wearable display device 100 (see FIG. 8A). The camera 107 placed upon the cap's button can also be the 360-degree camera which would provide an unobscured view of the word around the end user from the highest point of their body.

The microphone 108 can record audio in addition to the images/video the camera 107 captures but can also be utilized to detect audio cues. For example, if the Chicago Bulls create a content packet to be played out upon end user's hats, the United Center could play certain audio tones, potentially inaudible to human ears (e.g., ultrasonic tones), that would trigger synchronized displays around the stadium to create coordinated visually stunning effects. The ambient light sensor 109 can also be used to control the brightness of the display 104. For example, if the stadium lights in the example above all went black for an effect, the end user's hats may light up brighter to become more visible in the darkness.

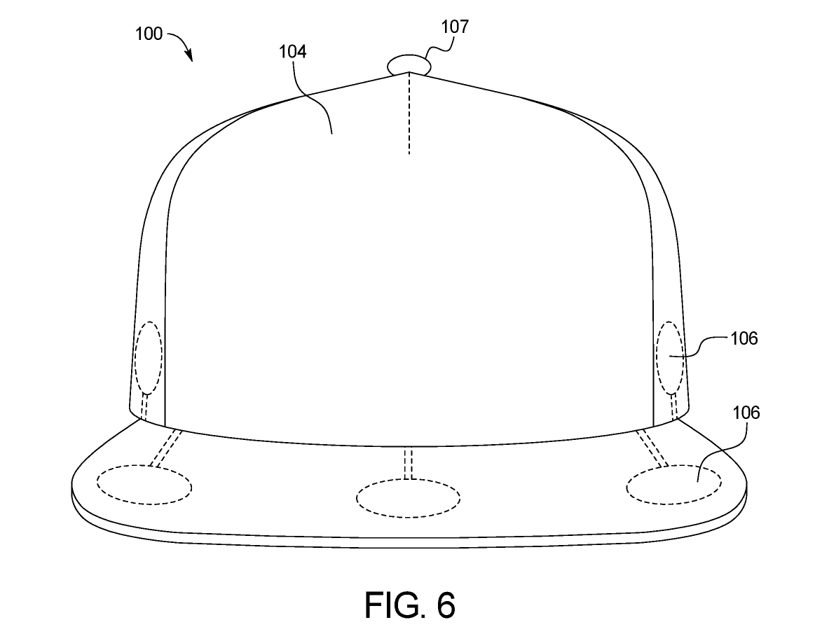

FIG. 6 is a front view of a wearable display device 100. As shown in FIG. 6, the wearable display device 100 may feature upon its exterior one of more capacitive touch inputs 106. These capacitive touch inputs 106, located on the brim and side panels of the hat, may enable an end user to control the wearable display device 100 without the need to utilize a mobile phone, tablet, etc. (mobile computing device 110, see FIG. 1). For example, the inputs may enable an end user to cycle through various content packs they have stored upon their device's 100 memory, adjust the brightness, take a picture or video with the camera 107, and power on/off the device 100. Each capacitive touch input 106 may be associated with a specific fixed function or each may be used to perform coordinated or universal actions. Additionally, these capacitive touch inputs can be used for games or gaming on the wearable display.

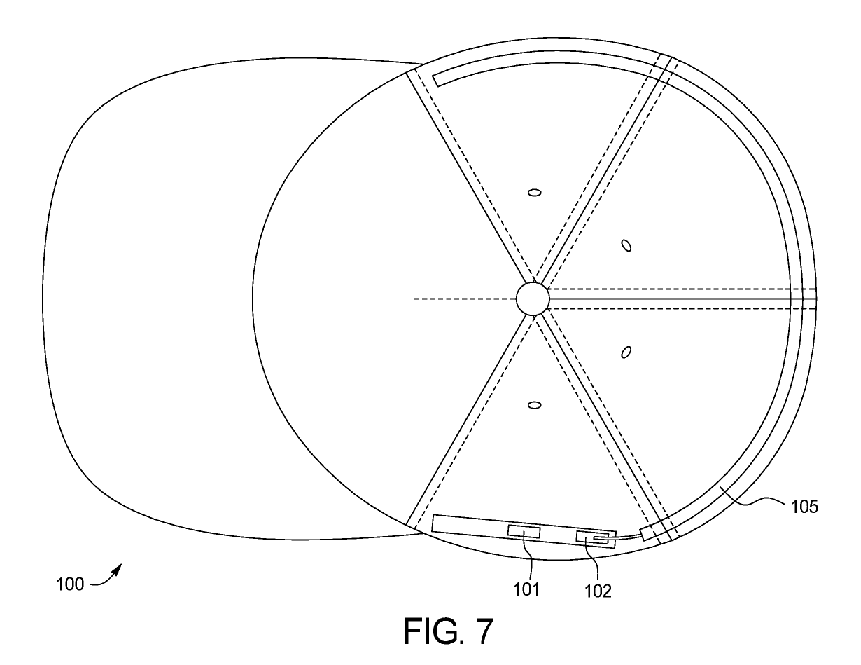

FIG. 7 is a bottom view of a wearable display device 100. As shown in FIG. 7, the wearable display device 100 may include, along the interior band of the cap, various electronic components. The computerized components that control and power the device (e.g., CPU 101, memory 102, power supply 105, etc.) are positioned in an ergonomic manner in this example and can be laid out as needed or as consumer demand dictates.

FIG. 8A is illustrates a mobile content display system 100 (e.g., a wearable display device 100) detecting a selfie. This could be a very important feature to advertisers, particularly if they are paying end users to display their logo or other content. As shown in FIG. 8A, the wearable display device 100 may be able to detect when an end user is taking a picture that will include the wearable display device 100. There are many different methods by which this feature can be implemented, wireless communication between the wearable display device 100 and a camera 115, recognition of the camera 115 by the wearable display device 100, etc.

In a first example, the selfie detection feature is done based off the mobile computing device 110 of the end user being placed in “selfie” mode. Almost all modern smartphones have a front facing camera 115 often used for taking selfies. When the front facing camera 115 is active, the mobile computing device 110 communicates to the wearable display device 100 to place the display 104 in selfie mode. The communication may be made by any wireless communication mechanism. In one example, the communication is made through a Bluetooth pairing of the wearable display device 100 and the mobile computing device 110 that is managed through a wearable device control application 210 running on the mobile computing device 110.

In selfie mode, the wearable device 100 configures the display 104 to display an image optimized for photography or videography. For example, if the Chicago Bears have a content packet for displaying the Bears logo interspersed with an animated video of a Bear stomping on a Green Bay Packer's logo, the selfie mode configuration of the content packet is the still image of the Bears logo. Therefore, when a user places the camera 115 of the mobile device 110 in selfie mode, the wearable display device 100 (e.g., a hat) automatically displays the still Bears logo until the camera 115 is deactivated. At this point the wearable display device 100 resumes playing the entirety of the content packet including the animated video portions, etc.

In another example, the ambient light sensor 109 may be utilized to detect a camera flash. In response to the flash detection, the wearable display device 100 may automatically switch to selfie mode ensuring each subsequent photo taken of the wearable device 100 features an optimized display of a given content pack.

The camera 107 and CPU 101 of the wearable display device 100 may use image and/or object recognition to determine that another camera may be taking a picture that will include the wearable display device 100. In addition to placing the wearable display device 100 in selfie mode, the wearable display device 100 may be able to be more specifically responsive. For example, if the camera 107 detects a camera that is located at an angle from which a photograph will cut off half of an advertiser's logo displayed on the display 104, the wearable display device 100 may automatically adjust placement of the logo on the flexible display 104 utilizing object recognition or image recognition algorithms to ensure the logo will show up fully in pictures taken of the wearable device 100.

FIG. 8B is a flowchart demonstrating a method of a mobile content display system 10 detecting a selfie. As shown in FIG. 8B, to begin selfie detection, the mobile device 110 which is linked to a wearable display device 100 may be placed into selfie mode (e.g., front facing camera activated) (step 271). The mobile computing device 110 will then communicate that its front facing mode has been activated to the wearable display device 100 (step 272). The wearable device 100 will then, upon its flexible display 104, update the image displayed to be optimized for a photograph (step 273). Such optimization may include centering a logo, making the display's 104 brightness higher, etc. After the display 104 is optimized, the end user may take one or more selfies of themselves wearing the device 100 (step 274). After the end user is done, the user then deactivates the camera 115 in the mobile computing device 110 (step 275). This deactivation is communicated to the wearable display device 100 (step 276), at which point the device 100 resumes playing animated images, videos, etc. (step 277).

It should be noted that various changes and modifications to the presently preferred embodiments described herein will be apparent to those skilled in the art. Such changes and modifications may be made without departing from the spirit and scope of the present invention and without diminishing its attendant advantages.

1. A media capture display optimization system comprising:
a wearable display device displaying dynamic media on a display, the wearable display device further including a first controller controlling the display, a memory storing the dynamic media and a static image, and a first wireless communication module;
a camera device including a second controller controlling a media capture module and a second wireless communication module;
wherein, in response to the second controller placing the media capture module in a media capture mode, the second wireless communication module communicates to the first wireless communication module; and
in response to the communication from the second wireless communication module, the first controller causes the display to display the static image.

2. The media capture display optimization system of claim 1, wherein the wearable display device is a hat.

3. The media capture display optimization system of claim 1, wherein the wearable display device is a shirt.

4. The media capture display optimization system of claim 1, wherein the display is a flexible display.

5. The media capture display optimization system of claim 1, wherein the dynamic media includes video.

6. The media capture display optimization system of claim 1, wherein the dynamic media includes dynamic display settings.

7. The media capture display optimization system of claim 1, wherein the camera device is a smartphone and the media capture mode includes activation of a front facing camera of the smartphone.

8. The media capture display optimization system of claim 1, wherein the camera device is a smartphone and the media capture mode includes activation of a camera of the smartphone.

9. The media capture display optimization system of claim 1, wherein media capture mode is a video capture mode.

10. The media capture display optimization system of claim 1, wherein media capture mode is a still image capture mode.

11. A system for enabling communication between two devices comprising:
a first device including a first contact identifier and an associated emoji code, wherein the emoji code is a unique set of one or more emojis in an ordered combination;
an emoji authentication server storing the association between the first contact identifier and the emoji code;
a second device that communicatively connects to the first device by providing the emoji code to the authentication server and, in response to the authentication server receiving the emoji code, the authentication server negotiates a communication connection between the first device and the second device.

12. The system of claim 11, wherein the first contact identifier is a phone number.

13. The system of claim 11, wherein the first contact identifier is an email address.

14. The system of claim 11, wherein the communication connection negotiated is a Bluetooth pairing.

15. The system of claim 11, wherein the communication connection negotiated is a phone call.

16. The system of claim 11, wherein the communication connection negotiated is an SMS communication.

17. The system of claim 11, wherein the communication connection negotiated is an email communication.

18. The system of claim 11, wherein the communication connection negotiated enables the communication of a data file between the first device and the second device.
